(19) United States
(12) Patent Application Publication
(10) Pub. No.: US 2019/0084496 A1
(43) Pub. Date: Mar. 21, 2019

(54) ADJUSTABLE UTILITY BOX FOR A VEHICLE

(71) Applicant: WILLIAM CRAIG POPE, LAKE WACCAMAW, NC (US)

(72) Inventor: WILLIAM CRAIG POPE, LAKE WACCAMAW, NC (US)

(73) Assignee: BOZEMAN BOX INC., LAKE WACCAMAW, NC (US)

(21) Appl. No.: 15/708,832

(22) Filed: Sep. 19, 2017

(51) Int. Cl. B60R 11/06

(52) U.S. Cl. CPC B60R 11/06; B60R 2011/0084

(57) ABSTRACT

An improved utility box for a vehicle having a cargo area that releasably attaches to the inner surfaces of the side walls of said cargo area without penetrating any surface of the vehicle. The utility box features a locking mechanism that protrudes from the side surfaces of the utility box to releasably engage with the inner surfaces of the sides of the cargo area. The locking mechanism can be a ratchet mechanism or a spring-loaded or cam-actuated telescoping bar. Preferred embodiments include a grommet or other sealing structure featured in the openings through which the locking mechanism protrudes. Still other embodiments include a foot pad made of a resilient, cushioning material at either end of the locking mechanism to provide cushioning and to protect the surfaces of the cargo area.

### BACKGROUND OF THE INVENTION

### (a) Field of the Invention

The present invention is in the technical field of storage containers. More particularly, the present invention is in the technical field of storage containers and associated locking mechanisms for vehicles featuring a cargo area.

### (b) Background Art

The pickup truck is a vehicle with an enclosed cab and an open cargo area having low sides and a tailgate. The first American pickup trucks were made by the Galion Allsteel Body Company from a modified Ford Model T in 1913. Originally designed to be a light duty work truck, Americans started purchasing the vehicles for general transportation, personal and recreational use as early as the 1950s. By 2016, pickup trucks accounted for roughly 18% of all vehicle purchases made in the United States. Pickup trucks are popular in part because they are durable and are higher off the ground than most passenger vehicles allowing them to be driven over rougher terrain. As a result, they are commonly found on construction and other work sites and are used for a variety of purposes. Consequently, pickup truck owners and operators frequently find themselves in need of a variety of tools and other implements when using their vehicles.

Naturally, there are a variety of companies that produce products and accessories to accommodate pickup truck owners and operators. One of the more commonly installed accessories is a utility box. There are many types of utility boxes used with modern pickup trucks. Some utility boxes attach to the sides of the cargo area of the pickup truck so that the equipment stored inside can be accessed by someone standing next to the truck. Other utility boxes fit between the cab and bed of the truck. In addition there are a variety of utility boxes that attach to the bed and/or sides of the truck and lay flat in the bed of the cargo area—typically covering most if not all of the floor space in the cargo area. Some of the most commonly purchased utility boxes are installed in the cargo area of the truck nearest the cab of the truck. These utility boxes are traditionally installed in the bed of the truck by inserting J-bolts or a similarly shaped structure into and through the underside of the tool box and sometimes the lip of the sides of the cargo area such that the threaded end of the bolt protrudes through the inner bottom surface of the toolbox and the lateral portion of the j-bolt is in contact with the underside of the truck's rails.

All of these configurations have a similar set of limitations. First, installing a utility box by passing a piece of hardware through a portion of the truck and utility box, severely limits the user's ability to move the utility box to another location within the bed of the truck and/or makes it difficult to uninstall the utility box. Second, the width of the utility box must match the width of the cargo area and as a result, such utility boxes cannot be a universal size. Moreover, it is necessary to install some form of padding on the sides of the pickup truck to prevent the utility box from damaging the truck. In addition, such an installation generally involves drilling holes in the sides of the truck and/or the bottom of the utility box making installation a rather involved process. Furthermore, long-term use of these types of utility boxes requires that they be tightened from time to time—doing so often involves accessing difficult to reach hardware/fastening devices. Most of these designs cannot be easily repositioned vertically or lengthwise. Finally, all of these configurations require the use of handheld tools to install, adjust, tighten and/or reposition the utility box.

### BRIEF SUMMARY OF THE INVENTION

The present invention is a utility box equipped with a locking mechanism that allows the user to conveniently install, reposition and/or remove the utility box in or from a vehicle having a cargo area. In its most basic form, the present application describes an improved utility box configured to releasably attach to the inner surfaces of the cargo area without penetrating or damaging any surface of the vehicle. Generally, a utility box has front and back surfaces, top and bottom surfaces and two side surfaces enclosing a cavity. The disclosed utility box features a locking mechanism that protrudes from the side surfaces of the utility box to releasably engage with the vehicle's cargo area. However, other embodiments of the utility box may have openings featured on other surfaces of the utility box to allow the locking mechanism to protrude from the front or back of the utility box. Still further embodiments include a utility box with more than one locking mechanism allowing more options when securing the utility box in the cargo area of a vehicle. The locking mechanism contains means to extend at least part of a locking bar outward away from the interior or cavity of the utility box and/or inward toward the same cavity or interior space. In some embodiments, the locking mechanism includes a telescoping bar with at least two sections and means to extend at least one section toward and/or away from the other section. The means to extend at least one section toward and/or away from another section can take a number of different forms including but not limited to a ratchet mechanism. Preferred embodiments of the ratchet mechanism include an elongated bar with notches on at least one surface of the bar and a pawl, gear wheel with teeth or lever that engages the notches as the user turns or manipulates the pawl, gear wheel or lever to advance the bar such that at least one end of the bar moves away from the ratchet mechanism. As a matter of fact, this configuration is the inventor's preferred embodiment and anticipated best mode of the locking mechanism.

Other embodiments include a telescoping bar having one section with a circumference greater than a second section—and means to extend at least one of the sections of the telescoping bar towards and/or away the other section of the telescoping bar. Those means can be threads featured on the exterior of a portion of the section with the smaller circumference and complementary threads on the interior of the other section such that the sections can be moved toward and away from each other by turning one section relative to the other section. Alternately, the means can be a spring installed in a section of the rod such that it applies an outward pressure to one or both of the sections of the rod. The spring is compressed when one section is moved toward the other section and can be locked into place through the use of a protrusion featured on one section that engages with a slot on the other section. Further means to extend one section of the telescoping bar away from the other can be a cylindrical cam with a groove carved into its surface that is engaged by a protrusion on the other section of the telescoping bar. As the cam is rotated, the protrusion moves through the groove and thereby pushes the section of the telescoping rod to which the protrusion is attached toward or away from the section containing the cam. Doing so moves the other section of the rod towards or away from the section containing the cam.

Further, preferred embodiments also include a grommet or other similar sealing structure featured in the openings through which the locking mechanism protrudes. Such grommets are preferably made of a resilient material such as rubber that is also water resistant. Such grommets will prevent moisture and debris from entering the utility box through the previously referenced openings.

Preferred embodiments may also include a non-skid foot that features a resilient, slip-resistant, cushioning material and water resistant material, such as rubber, at either end of the locking mechanism. These feet provide cushioning between the ends of the locking mechanism and the surface of the vehicle, obviating the need to install some sort of protective material on a surface of the vehicle.

To install the device, the user physically places the utility box into the cargo area of the vehicle and positions it to their liking. Next, the user opens the cargo box and manipulates the locking mechanism to extend one or more of the sections of the locking mechanism through one or more of the openings featured by the utility box such that the padded foot at either end of the locking mechanism engages with a surface of the vehicle, typically the inner surface of the side walls of the cargo area.

The locking mechanism can be detachable but is generally meant to be installed in the utility box. Some mechanisms will feature one end of the locking mechanism in a fixed position relative to the utility box and only the second end of the locking mechanism is capable of being extended. In other embodiments, both ends of the locking mechanism can be extended towards or away from the rest of the utility box as needed.

### BRIEF DESCRIPTION OF THE SEVERAL VIEWS OF THE DRAWINGS

FIG. 1 is a perspective view of the utility box open and closed and featuring a first embodiment of the locking mechanism;

FIG. 2A is a perspective view of one version of the ratchet mechanism;

FIG. 2B is a top plan view the same first embodiment of the locking mechanism;

FIG. 2C is a side plan view of the same first embodiment of the locking mechanism;

FIG. 3 is a side plan view of a second embodiment of the ratchet mechanism;

FIG. 4A is a top perspective of a third embodiment of the locking mechanism with part of the locking mechanism magnified;

FIG. 4B is a top perspective view of the intersection of the two sections of the locking mechanism featured in the third embodiment of the locking mechanism;

FIG. 5 is a perspective view of a fourth embodiment of the locking mechanism; and

FIGS. 6A through 6D show perspective views showing the openings on the utility box.

### DETAILED DESCRIPTION OF THE INVENTION

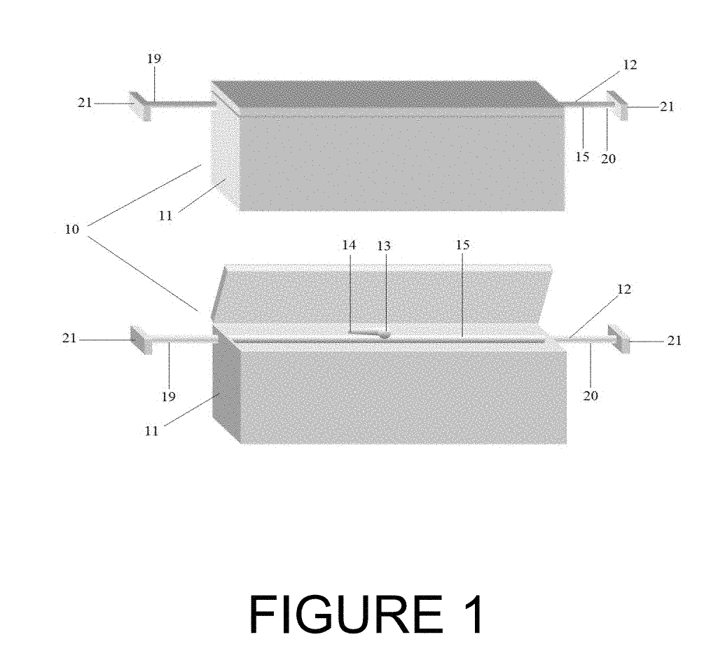

Referring now to the invention in more detail, in FIG. 1 there is shown a preferred embodiment and the inventor's anticipated best mode of the inventive utility box 10. More specifically, FIG. 1 shows the utility box equipped with a locking mechanism 12. In this embodiment, the locking mechanism is a ratchet 13 with a pawl 14 and a bar 15 featuring notches (not shown). The utility box is shown in an open and a closed configuration. Both configurations show the locking mechanism 12 protruding from each of the two side surfaces 11 of the utility box 10. The locking mechanism 12 has a first end 19 and a second end 20 each featuring a foot 21 configured to contact the walls of the vehicle's cargo area. FIG. 1 also shows the ratchet mechanism 13 that is used to extend one or both of the first 19 and second ends 20 of the locking mechanism 12 toward and away from the utility box 10.

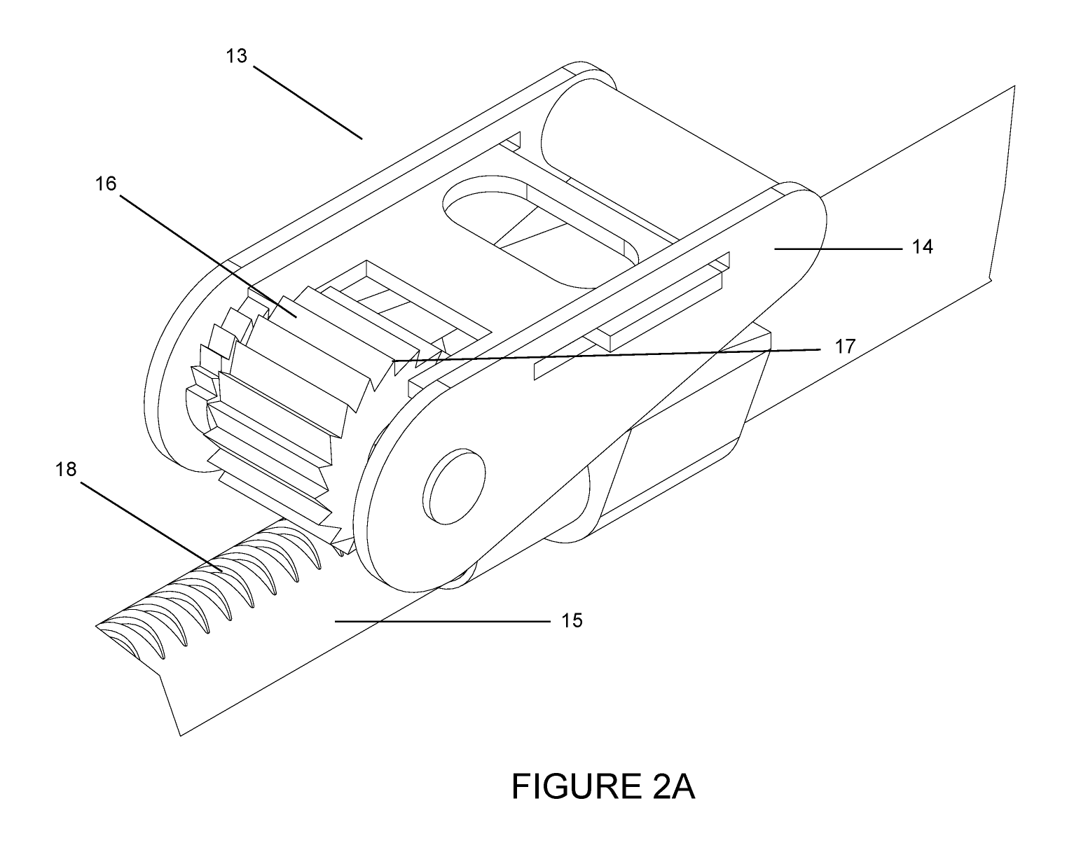

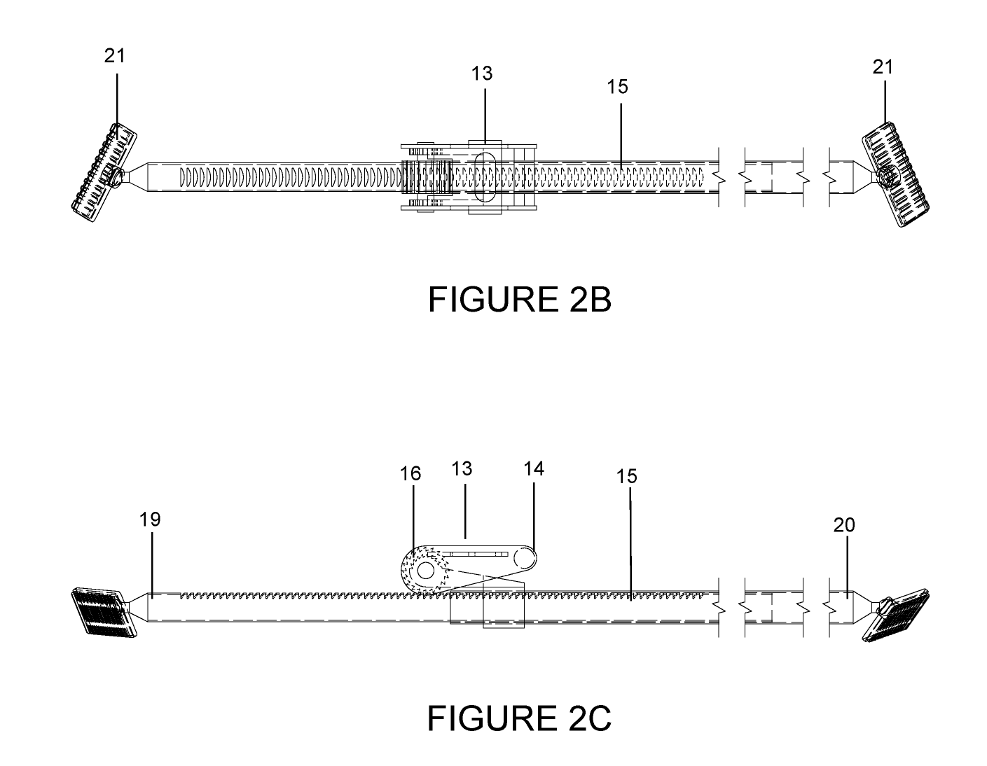

FIGS. 2A, 2B and 2C show the locking mechanism shown in FIG. 1. Specifically, FIGS. 2A, 2B and 2C show the ratchet mechanism 13 made of a gear wheel 16 with teeth 17, a pawl 14 and a mount or bar 15 featuring notches 18. The teeth 17 on the gear wheel 16 are complementary to the notches 18 on the bar 15. In operation, the user raises and lowers the pawl 14 causing the gear wheel 16 to turn. As the teeth 17 on the gear wheel 16 rotate, they engage and disengage with the notches 18 on the bar or mount 15. Thereby the pawl 14 advances the bar 15. As the bar 15 and its notches 18 advance, the teeth 17 on the gear wheel 16 engage notches 18 on the bar 15 preventing backwards motion of the bar 15 until the bar 15 is released from the pawl 14 allowing it to slide back to its starting position. In that manner, the user is able to advance or retract one or both ends 19, 20 of the locking mechanism 12 to engage the feet 21 with a separate surface such as the inner walls of the cargo area of the vehicle.

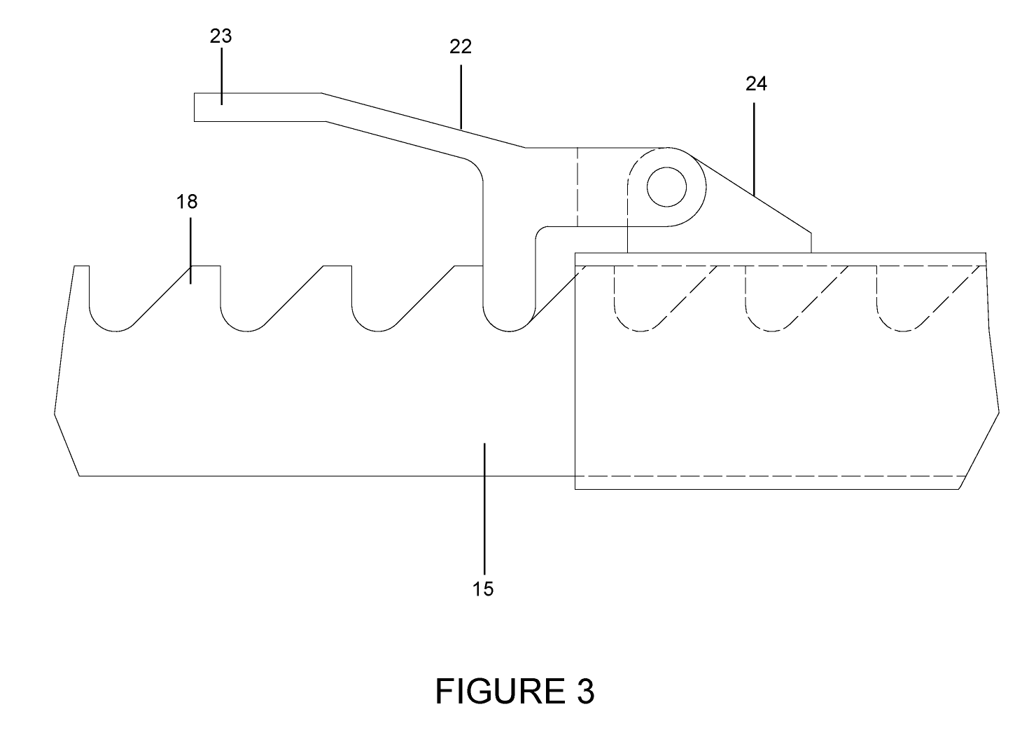

FIG. 3 shows an alternate embodiment of the locking mechanism 12 shown in FIGS. 1 and 2. Namely, FIG. 3 shows an alternate version of the ratchet mechanism 13 made of a lever 22 that engages with a mount or bar 15 featuring notches 18. In operation, the user raises and lowers a handle 23 of the lever 22 causing a far end 24 of the lever 22 to engage one of the notches 18 featured on the bar 15. As the user lifts a handle 23, the far end 24 of the lever 22 engages one of the notches 18 of the bar 15, pushing the bar 15 toward the handle 23. As the handle 23 is depressed, the far end 24 of the lever 22 disengages with the notches 18 of the bar 15 and the handle 23 engages with the notch(es) 18 that are adjacent to it. When the handle 23 is engaged with the notches 18 of the bar 15, the bar 15 is held securely in place. In this manner, the user is able to advance or retract one or both ends 19, 20 of the locking mechanism 12 to engage the feet (not shown) with the inner walls of the cargo area of the vehicle.

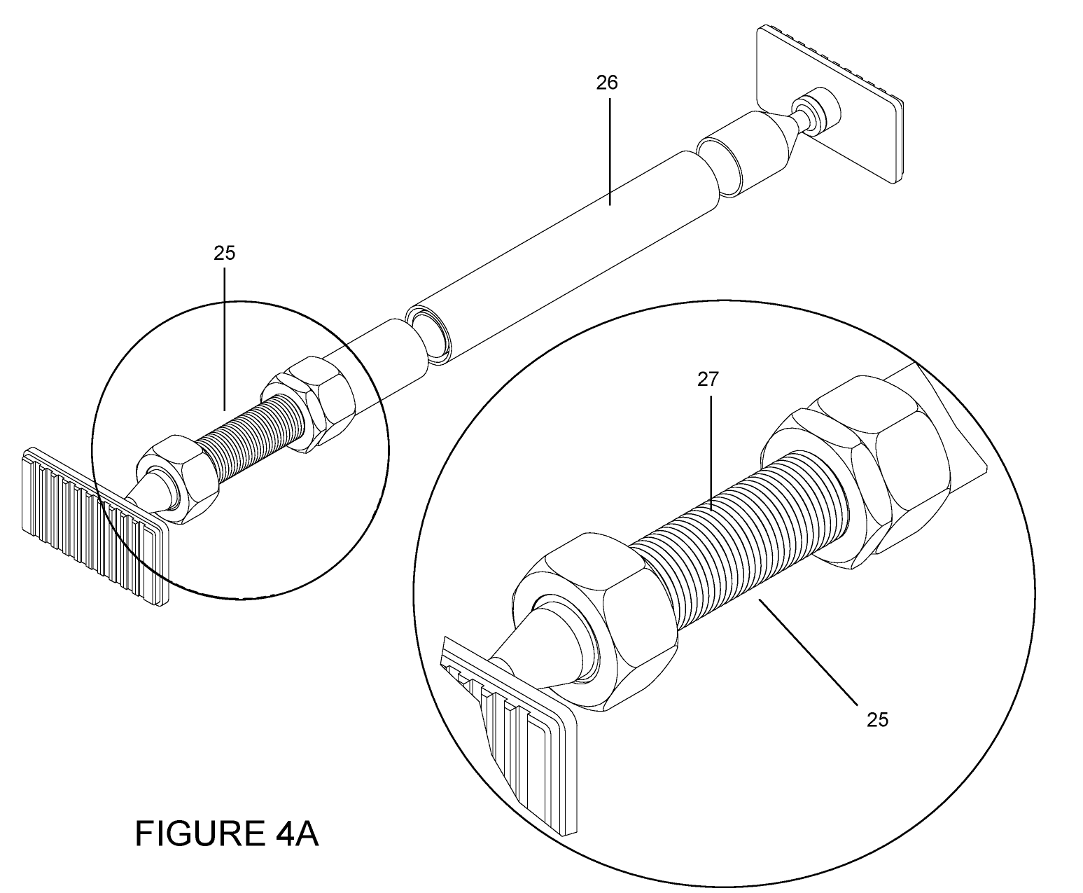

FIG. 4A shows an alternate embodiment of the locking mechanism 12. Specifically, in this embodiment, the locking mechanism 12 consists of a first rod 25 featuring threads 27 on its outer surface that are complementary to threads (not shown) featured on an inner surface of a second rod 26. As the first rod 25 is turned in one direction, the first rod 25 is threaded further into the second rod 26. As the first rod 25 is turned in the opposite direction, the threads 27 of each of the two rods 25, 26 disengage and the first rod 25 is moved out of the second rod 26. FIG. 4B shows a close up of the point at which the first rod 25 and the second rod 26 meet. The second rod 26 featuring internal threads 28 has a first nut 29 at the same end that interacts with the first rod 25. In preferred embodiments, this first nut 29 is welded in place at the end point where the two rods 25, 26 meet. In still further preferred embodiments, the first rod 25 also features a second nut 30 possibly a jam nut at the same point of intersection of the two rods 25, 26.

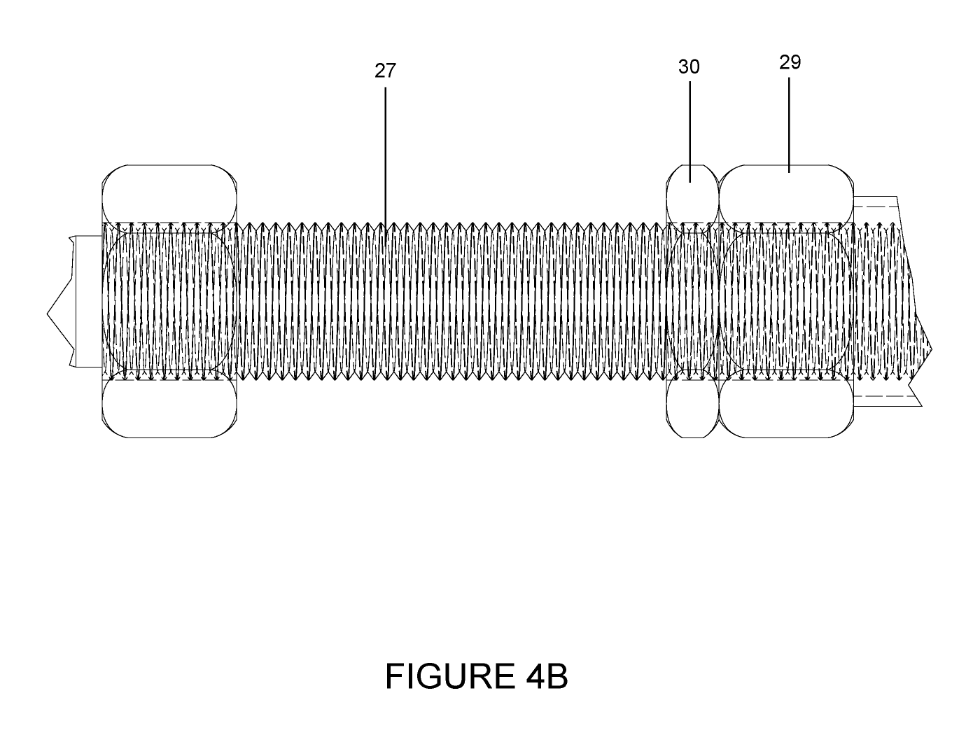

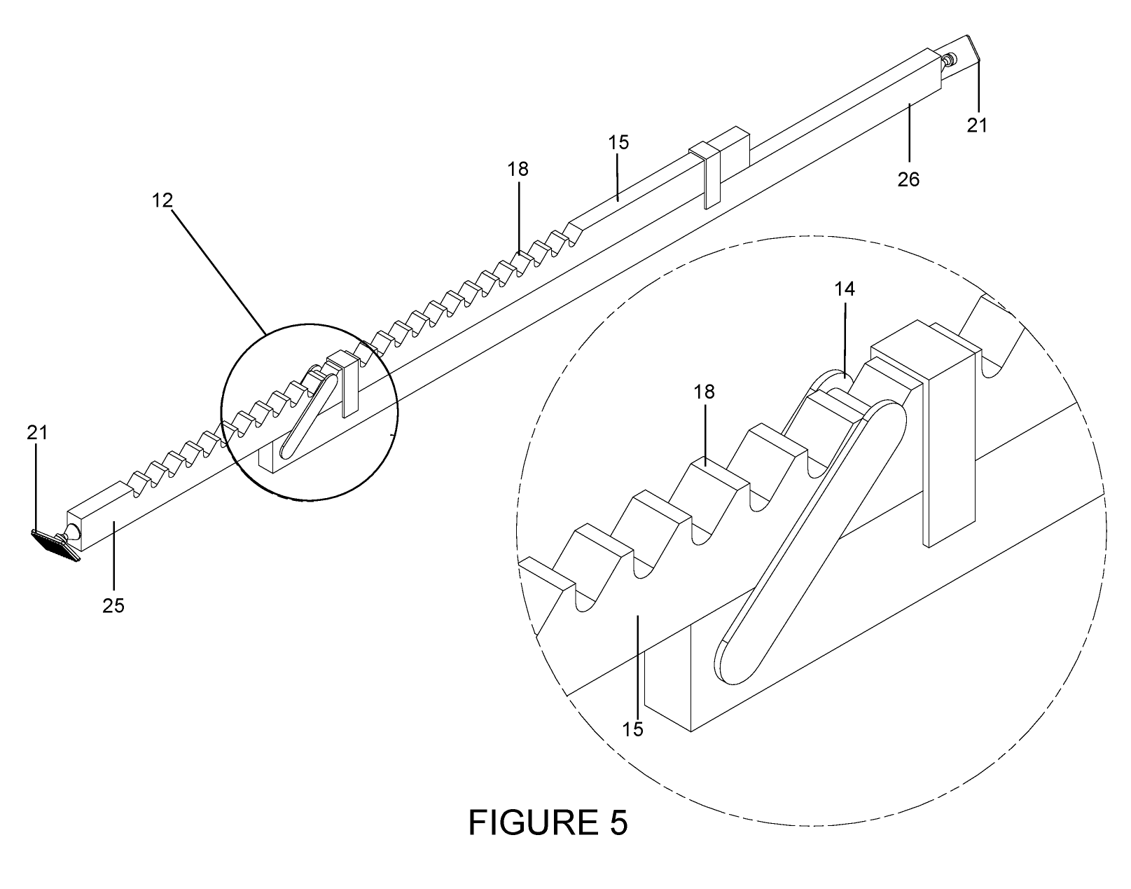

FIG. 5 shows yet another embodiment of the locking mechanism 12. In this embodiment, the locking mechanism 12 features the same bar 15 with notches 18 and a pawl 14. The pawl 14 consists of an elongated piece of material with a first end attached to the bar 15 and a second end configured to engage the notches 18 of the bar 15. In this embodiment, the pawl 14 can be lifted such that it ceases to engage the notches 18 of the bar 15 so that the bar can be moved one way or another before the pawl 14 is lowered to engage the notches 18 again. Once engaged with the notches 18, the pawl 14 prevents the bar 15 from moving in either direction. In this manner, the user is able to advance or retract one or both ends 25, 26 of the locking mechanism 12 to engage the feet 21 with the inner walls of the cargo area of the vehicle.

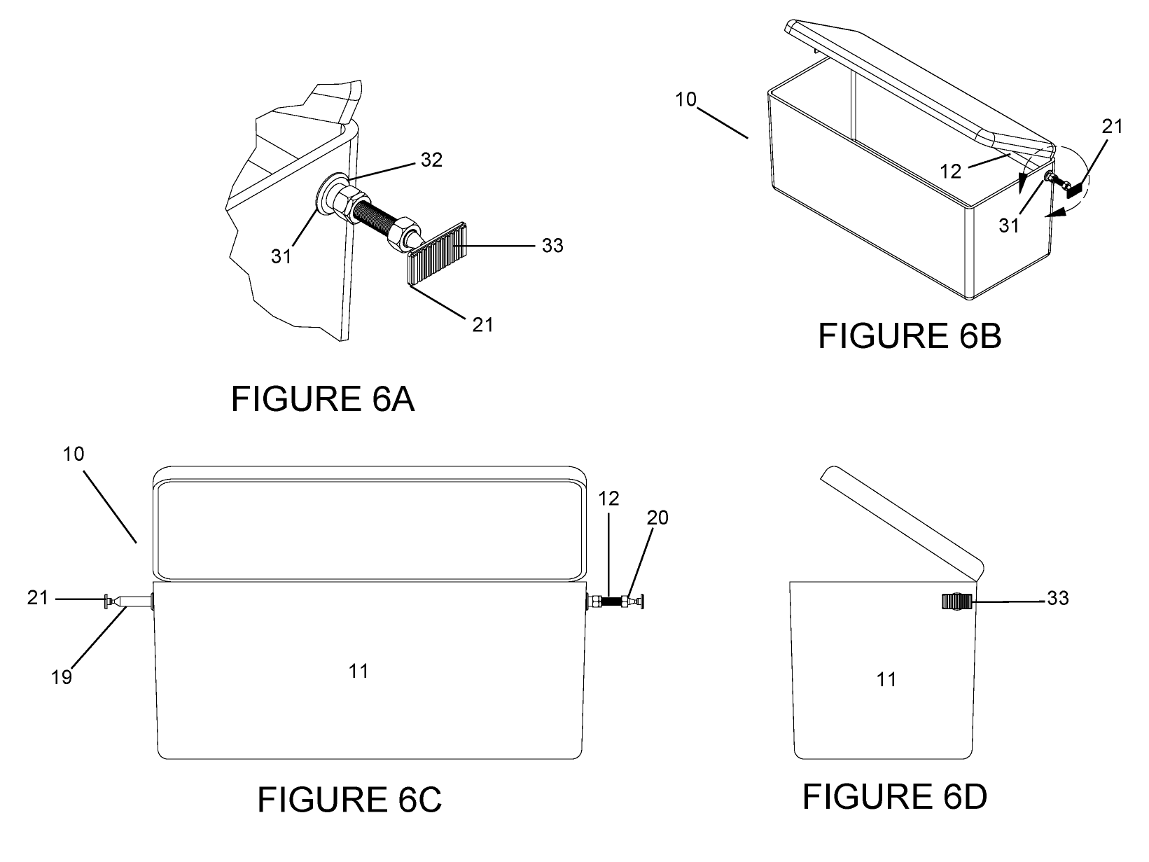

FIGS. 6A through 6D show the utility box 10 with the integrated locking mechanism 12 protruding from the side surfaces 11 of the utility box 10. In more detail, the utility box 10 features one or more openings 31 in one or more surfaces of the utility box 10. In preferred embodiments and the inventor's anticipated best mode, the utility box features at least two openings 31, at least one in each of the two side surfaces 11 of the utility box 10. The locking mechanism 12 is integrated or inserted into the interior of the utility box 10 and each of the first 19 and second ends 20 of the locking mechanism 12 pass through the openings 31 in the utility box 10. In preferred embodiments, the openings are sealed with grommets 32. The grommet(s) 32 can be cut out and shaped to match the chosen locking mechanism 12. Furthermore, FIG. 6 shows one of the feet 21 featuring cushioning material 33 located at the end of the locking mechanism 12. As discussed above, the cushioning material 33 provides a buffer or contact point between the locking mechanism 2 and the cargo area of the vehicle and obviates the need for any other protective material to be installed between the vehicle and the locking mechanism 12 and/or the utility box 10.

The advantages of the present invention include, without limitation, the ability to quickly and easily install a utility box into the cargo area of a vehicle without using any tools other than the user's own two hands. In addition, the disclosed utility box and locking mechanism constitute a significant departure from the prior art in that the utility box is easy to remove, tighten or reposition with said cargo area. As a matter of fact, the utility box can be positioned such that there is space or a gap between the utility box and either the inner surfaces of the side walls of the cargo area and/or the bed or floor of the cargo area. Furthermore, the utility box can be installed parallel or perpendicular to the side walls of the vehicle's cargo area. Moreover, the same utility box can be installed in different sizes of cargo areas. Further, the utility box need not rest on the sides walls of the cargo area and there is no need to drill holes in the utility box or any portion of the truck. These and other advantages will be evident to one of ordinary skill in the relevant art.

In broad embodiment, the present invention is a utility box with means to attach the to the inner surfaces of the walls of a vehicle's cargo area without penetrating those same walls.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I/We claim:

1. A adjustable utility box for a vehicle configured to be detachable from the vehicle comprising:
a locking bar configured to releasably engage with a surface of the vehicle without penetrating said surface.

2. The adjustable utility box of claim 1 wherein the locking bar comprises:
a telescoping bar with a first end and a second end, and
at least one foot pad located at both the first end and the second end; said foot pads featuring a cushioning material.

3. The adjustable utility box of claim 2 wherein the utility box features at least one opening in an outer surface and the telescoping bar is inserted through the at least one opening.

4. The adjustable utility box of claim 3 wherein the at least one opening in the outer surface of the utility box is sealed with a grommet.

5. The adjustable utility box of claim 2 wherein the telescoping bar has a first section and a second section and the first section has a larger diameter than the second section; said second section is configured to be inserted into the first section; and wherein the telescoping rod contains means to extend one of the sections of the telescoping bar away or towards the other section of the telescoping bar.

6. The adjustable utility box of claim 1 wherein the locking bar has a ratchet comprising an elongated bar with notches in a surface of the bar and a pawl that engages said notches and is configured to move the locking bar away from the pawl.

7. The adjustable utility box of claim 1 wherein the locking bar has a first end and a second end; the first end and the second end being configured to releasably engage with a surface of the vehicle without penetrating said surface; and
an opening in each of the at least two opposing side surfaces of the utility box; wherein the first end of the locking bar is inserted into the first side surface of the utility box and the second end of the locking bar is inserted through the second side surface of the utility box.

8. The adjustable utility box of claim 2 wherein the telescoping bar has a first end and a second end; the first end and the second end being configured to releasably engage with a surface of the vehicle without penetrating said surface; and
an opening in each of the at least two opposing side surfaces of the utility box; wherein the first end of the locking bar is inserted into the first side surface of the utility box and the second end of the locking bar is inserted through the second side surface of the utility box.

9. The adjustable utility box of claim 5 wherein the telescoping bar has a first end and a second end; the first end and the second end being configured to releasably engage with a surface of the vehicle without penetrating said surface; and
an opening in each of the at least two opposing side surfaces of the utility box; wherein the first end of the locking bar is inserted into the first side surface of the utility box and the second end of the locking bar is inserted through the second side surface of the utility box.

10. The adjustable utility box of claim 6 wherein the locking bar has a first end and a second end; the first end and the second end being configured to releasably engage with a surface of the vehicle without penetrating said surface; and
an opening in each of the at least two opposing side surfaces of the utility box; wherein the first end of the locking bar is inserted into the first side surface of the utility box and the second end of the locking bar is inserted through the second side surface of the utility box.

11. A locking mechanism for a utility box installed in a vehicle comprising:
a locking bar with a first end and a second end; the first end of the locking bar inserted through an opening in a side surface of the utility box and a second end of the locking bar is inserted through an opening in a second side surface that is positioned to be directly opposed to the first side surface; and
a first foot pad located on the first end of the telescoping bar and a second foot pad located on the second end of the telescoping bar; each foot pad being made of a resilient material.

12. The attachment mechanism of claim 11 wherein the locking bar is a ratchet comprising an elongated bar with teeth in a surface of the bar and a pawl that engages said teeth.

13. The attachment mechanism of claim 11 wherein the locking bar is a telescoping bar with a first section and a second section and the first section has a larger diameter than the second section; said second section configured to be inserted into the first section and wherein the telescoping rod contains means to extend and retract one of the sections of the telescoping bar toward or away from the other section of the telescoping bar.

14. The attachment mechanism of claim 11 wherein the opening in the first side surface of the utility box and the opening in the second side surface of the utility box each features a grommet.

15. A adjustable detachable utility box for a vehicle comprising:
a first side surface and a second side surface, said side surfaces located at opposite, opposing ends of the utility box;
a first opening in the first side surface of the utility box and a second opening in the second side surface of the utility box wherein each opening features a grommet;
a locking bar with a first end and a second end; the first end and the second end being configured to releasably engage with a surface of the vehicle without penetrating said surface; and
an opening in each of the at least two opposing side surfaces of the utility box; wherein the first end of the locking bar is inserted into the first side surfaces of the utility box and the second end of the locking bar is inserted through the second side surface of the utility box.

16. The adjustable, detachable utility box for a vehicle of claim 15 wherein the locking bar features a ratchet comprising an elongated bar with notches in a surface of the bar and a pawl that engages said notches; said pawl configured to move the locking bar with respect to the pawl.

17. The attachment mechanism of claim 15 wherein the locking bar is a telescoping bar with a first section and a second section and the first section has a larger diameter than the second section; said second section configured to be inserted into the first section and wherein the telescoping rod contains means to extend and retract one of the sections of the telescoping bar toward or away from the other section of the telescoping bar.

18. The adjustable, detachable utility box for a vehicle of claim 15 further comprising:
at least one foot pad located at both the first end and the second end of the locking bar; the at least one foot pad featuring a cushioning material.

19. The adjustable, detachable utility box for a vehicle of claim 16 further comprising:
at least one foot pad located at both the first end and the second end of the locking bar; the at least one foot pad featuring a cushioning material.

20. The adjustable, detachable utility box for a vehicle of claim 17 further comprising:
at least one foot pad located at both the first end and the second end of the locking bar; the at least one foot pad featuring a cushioning material.
